(19) United States
(12) Patent Application Publication
(10) Pub. No.: US 2019/0049709 A1
(43) Pub. Date: Feb. 14, 2019

(54) LIGHT SHEET MICROSCOPE

(71) Applicant: OLYMPUS CORPORATION, Tokyo (JP)

(72) Inventors: Yoshihiro SHIMADA, Sagamihara (JP); Go RYU, Tokyo (JP)

(73) Assignee: OLYMPUS CORPORATION, Tokyo (JP)

(21) Appl. No.: 16/050,171

(22) Filed: Jul. 31, 2018

(30) Foreign Application Priority Data
Aug. 8, 2017 (JP) 2017-153350

(51) Int. Cl. G02B 21/06; F21V 8/00; G02B 21/16

(52) U.S. Cl. CPC G02B 21/06; G02B 21/16; G02B 6/0005

(57) ABSTRACT

A light sheet microscope includes a light source configured to output light, a plurality of optical fibers configured to guide the light that is from the light source, a plurality of illumination optical systems configured to respectively emit beams of the light guided from the plurality of optical fibers toward a sample as light sheets in a plurality of different directions on a same plane, and a light switching device that is provided between the light source and the plurality of optical fibers and that is configured to switch an optical fiber that the light output from the light source enters, from among the plurality of optical fibers.

### CROSS REFERENCE TO RELATED APPLICATIONS

This application is based upon and claims the benefit of priority from prior Japanese Patent Application No. 2017-153350, filed Aug. 8, 2017, the entire contents of which are incorporated herein by this reference.

### BACKGROUND OF THE INVENTION

### Field of the Invention

The present invention is related to a light sheet microscope.

### Description of the Related Art

A light sheet microscope is known, in which the sample is irradiated with beams of excitation light in a plurality of different directions on the same plane. For example, illuminating the sample in two (a plurality of) directions on the same plane can suppress the reduction in the illumination efficiency in an area on the sample that is distant from the illumination optical system, whereas such reduction would be caused by a configuration illuminating the sample in one direction. It can also prevent the occurrence of variations of the illumination efficiency on the irradiated plane. Illuminating the sample in different directions also leads to the reduction in the occurrence of an area that is prevented by a scattering medium etc. from being irradiated with excitation light (occurrence of shadow) on the sample.

Japanese National Publication of International Patent Application No. 2013-506152 and U.S. Unexamined Patent Application Publication No. 2011/0115895 disclose a configuration in which the sample is irradiated with excitation light in two directions. These techniques change the illumination direction between two directions by employing an optical path that is branched by a galvanometer mirror in the illumination optical system.

Some of the techniques that illuminate the sample in a plurality of directions achieve quasi simultaneous illumination, in which the sample is illuminated alternately in two directions. The technique in National Publication of International Patent Application No. 2013-506152 above changes the illumination direction during exposure. U.S. Unexamined Patent Application Publication No. 2011/0115895 discloses a technique in which images respectively under illumination in two directions are obtained and an image process is performed later to obtain one image.

### SUMMARY OF THE INVENTION

A light sheet microscope according to an aspect of the present invention includes a light source configured to output light, a plurality of optical fibers configured to guide the light that is from the light source, a plurality of illumination optical systems configured to respectively emit beams of the light guided from the plurality of optical fibers toward a sample as light sheets in a plurality of different directions on a same plane, and a light switching device that is provided between the light source and the plurality of optical fibers, that is configured to switch an optical fiber that the light output from the light source enters, from among the plurality of optical fibers, and that is configured to switch an illumination optical system to emit light, from among the plurality of illumination optical systems.

A light sheet microscope according to another aspect of the present invention includes a light source configured to output light, a plurality of optical fibers configured to guide the light that is from the light source, a plurality of illumination optical systems configured to respectively emit beams of the light guided from the plurality of optical fibers toward a sample as light sheets in a plurality of directions on a same plane, a light splitting device configured to split the light so as to make the light output from the light source guide, to optical paths respectively connected to the plurality of optical fibers, and a light blocking mechanism that passes or blocks light on each optical path resulting from the splitting by the light splitting device.

Alight sheet microscope according to another aspect of the present invention includes a plurality of light sources configured to output light, a plurality of illumination optical systems configured to respectively emit beams of light that are from the plurality light sources toward a sample as light sheets in a plurality of directions on a same plane, and a light switching device configured to switch an illumination optical system to emit light, from among the plurality of illumination optical systems.

### BRIEF DESCRIPTION OF THE DRAWINGS

The present invention will be more apparent from the following detailed description when the accompanying drawings are referenced.

FIG. 1 illustrates a configuration of a light sheet microscope according to the first embodiment;

FIG. 2 illustrates a functional configuration of a control device;

FIG. 3 illustrates a configuration of a light sheet microscope according to the second embodiment;

FIG. 4 illustrates a configuration of a light sheet microscope according to the third embodiment;

FIG. 5 illustrates a configuration of a light sheet microscope according to the fourth embodiment; and

FIG. 6 illustrates a section of a shutter according to the fourth embodiment.

### DESCRIPTION OF THE EMBODIMENTS

Incidentally, a galvanometer mirror may have a variation in the amount of a change in the angle, accompanying changes in the observation environment including aged deterioration and temperature changes.

Such deterioration of the accuracy in a mechanism that changes the illumination direction may hinder the emission of excitation light in respective in directions. For example, the above variation in the amount of a change in the angle changes the direction in which the excitation light is guided after the optical path is branched by the galvanometer mirror in the illumination optical system. The variation may cause a shift on the plane irradiated with the excitation light for each illumination direction.

In recent years, an observation using a thinner sheet light is desired in order to achieve higher resolution in the observation. However, the thinner the sheet light on the sample is, the more remarkable the influence of the above shift is on the plane irradiated with the excitation light.

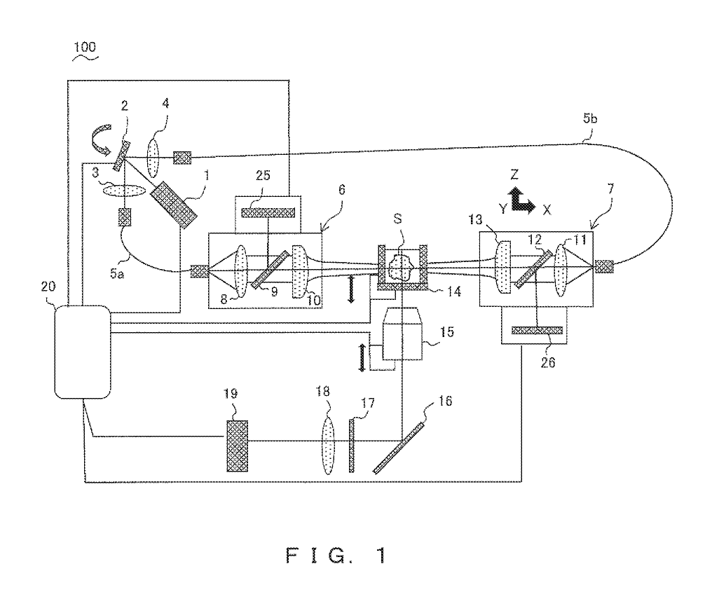

Hereinafter, explanations will be given for a light sheet microscope 100 according to the first embodiment of the present invention. FIG. 1 illustrates a configuration of the light sheet microscope 100.

The light sheet microscope 100 includes alight source 1, a galvanometer mirror 2, lenses 3 and 4, optical fibers 5a and 5b, illumination optical systems 6 and 7, and the light-amount measurement devices 25 and 26. The light sheet microscope 100 further includes an objective 15, a mirror 16, a fluorescence filter 17, a lens 18, a light detector 19, and a control device 20. Note that sample S is in an optically transparent container 14 together with a culture fluid etc, and is fixed to a stage (not illustrated).

The light source 1 outputs light (excitation light) with which to irradiate sample S.

The galvanometer mirror 2 deflects the excitation light output from the light source 1. In more detail, the galvanometer mirror 2 operates within a prescribed angle range so as to deflect the excitation light so that the light enters the lens 3 or 4. In other words, the galvanometer mirror 2 is a light deflection device switching the optical fiber that the excitation light enters, from among the plurality of optical fibers (optical fibers 5a and 5b).

The optical fibers 5a and 5b guide beams of excitation light that respectively passed through the lenses 3 and 4 to the illumination optical systems 6 and 7.

The illumination optical system 6 includes a lens 8, a beam splitter 9, and a cylindrical lens 10. The excitation light that has passed through the lens 8, and is split into two beams. One is reflected by the beam splitter 9 and travels toward a light-amount measurement device 25. The other is transmitted through the beam splitter 9 and travels toward the cylindrical lens 10.

The cylindrical lens 10 has a power only in the Z directions, and irradiates sample S with sheet-shape excitation light (sheet light) expanding on the X-Y plane. Note that directions in which the sheet light expands will be referred to as width directions in addition to illumination light axis directions. The width directions of the sheet light emitted from the illumination optical system 6 are Y directions in FIG. 1.

The illumination optical system 7 includes a lens 11, a beam splitter 12, and a cylindrical lens 13. The lens 11, the beam splitter 12, and the cylindrical lens 13 are similar respectively to the lens 8, the beam splitter 9, the cylindrical lens 10 of the illumination optical system 6, and the illumination optical system 7 includes constituents similar to those of the illumination optical system 6. The excitation light that has passed through the lens 11 is split into two beams, i.e., one that is reflected by the beam splitter 12 and travels toward a light-amount measurement device 26 and the other that is transmitted through the beam splitter 12 and travels toward the cylindrical lens 13.

As described above, the light sheet microscope 100 includes a plurality of illumination optical systems that emit excitation light (sheet light) toward sample S in a plurality of directions (two opposed directions on the X axis in this example) on the same plane, i.e., on the same axis. Also, the galvanometer mirror 2 functions as a light switching device operating and switching the optical path so that the excitation light enters the lens 3 or lens 4, thereby to switch the illumination optical system to emit the excitation light, from among the above plurality of illumination optical systems (the illumination optical systems 6 and 7).

As a general rule, a galvanometer mirror that operates to change the angle may have a variation in the amount of a change in the angle in response to the operation because of aged deterioration and temperature changes. This means that in a microscope using a galvanometer mirror to switch the illumination direction from among a plurality of directions, when the amount of a change in the angle becomes out of the inherent range in the galvanometer mirror, the direction of the light entering the subsequent optical system changes.

In the conventional configurations of light sheet microscopes, angle changes due to aged deterioration, temperature changes, etc. have caused changes in the illumination direction. In particular, for light sheet microscopes, which irradiate sample S with a sheet light expanding on a plane, the changes in the illumination directions greatly influence the observation because changes in the illumination directions cause shifts of the irradiated planes between the illumination optical systems.

The light sheet microscope 100 of the first embodiment according to the present invention includes the optical fibers 5a and 5b, arranged subsequently to the galvanometer mirror 2, that are configured to guide the excitation light respectively to a plurality of illumination optical systems (illumination optical systems 6 and 7). The excitation light is guided to the subsequent illumination optical system through the optical fiber corresponding to the light switching state so as to emit the excitation light to sample S. This prevents changes in the emission direction of the excitation light at the emission edge of the optical fiber from which the excitation light is emitted even when the galvanometer mirror 2 has a variation in amount of a change angle due to aged deterioration etc. and the excitation light has traveled in a changed direction. In other words, providing an optical fiber to a stage subsequent to the light switching device that may cause a shift in the traveling direction of the excitation light can prevent the occurrence of a shift in the illumination direction to sample S.

The configuration of the light sheet microscope 100 will be explained again.

The light-amount measurement device 25 measures the light amount of the excitation light detected via the beam splitter 9. The light amount measured by the light-amount measurement device 25 is for example the light amount per a fixed period of time that is set in advance. The light-amount measurement device 26 and the light-amount measurement device 25 are similar to each other, and the light-amount measurement device 26 similarly measure the light amount from the excitation light detected via the beam splitter 12. In other words, the light sheet microscope 100 includes a plurality of light-amount measurement devices (the light-amount measurement device 25 and the light-amount measurement device 26) that measure the light amount of the excitation light that passes through the respective illumination optical systems.

The fluorescence generated from sample S passes through the objective 15, the mirror 16, the fluorescence filter 17, and the lens 18, and is detected by the light detector 19. An example of the light detector 19 is an image-pickup element such as a CCD image sensor etc.

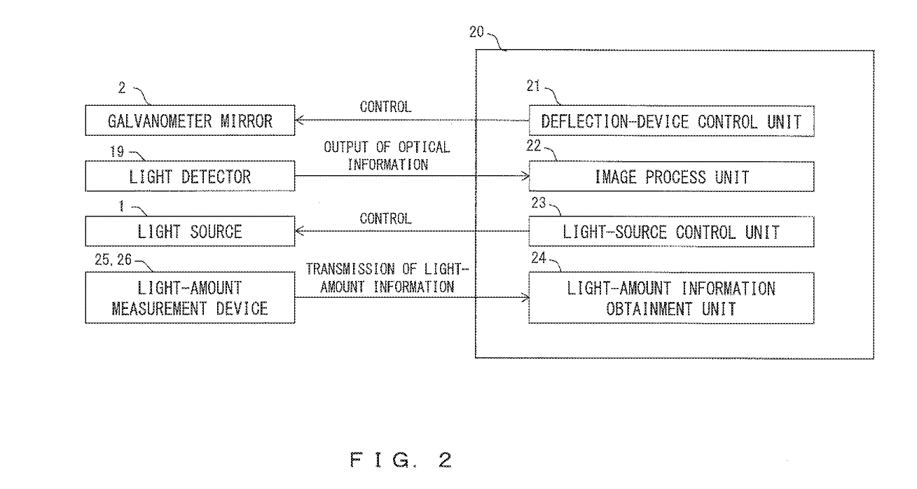

The control device 20 is a computer that controls the respective constituents belonging to the light sheet microscope 100. FIG. 2 illustrates a functional configuration of the control device 20.

The control device 20 includes a deflection-device control unit 21, an image process unit 22, a light-source control unit 23, and a light-amount information obtainment unit 24.

The deflection-device control unit 21 controls the operation of the galvanometer mirror 2, which is a light switching device, and performs control to switch the illumination optical system to emit the excitation light between the illumination optical systems 6 and 7. The deflection-device control unit 21 may perform control on the basis of an input to the control device 20 from an input device (not illustrated) such as a keyboard, a mouse, etc.

The image process unit 22 performs various processes including the generation of an image on the basis of a signal of the fluorescence detected by the light detector 19.

The light-source control unit 23 changes, on the basis of the light amount measured by the light-amount measurement device 25, the intensity of the excitation light that the light source 1 outputs, and thereby adjusts the light amount of the excitation light that the illumination optical systems 6 and 7 emit. More specifically, the light-source control unit 23 changes the intensity of the excitation light output from the light source 1 upon the emission of the excitation light from each of the illumination optical systems 6 and 7. This eliminates the difference between the light amount measured by the light-amount measurement device 25 and The light-amount measurement device 26, the light amount measured by the light-amount measurement device 25 being measured when the galvanometer mirror 2 switches the optical path through which the excitation light passes and thereby sample S is irradiated with the excitation light through the illumination optical system 6, and the light amount measured by the light-amount measurement device 26 being measured when the galvanometer mirror 2 switches the optical path through which the excitation light passes and thereby sample S is irradiated with the excitation light through the illumination optical system 7.

Also, the light-amount information obtainment unit 24 receives information of the light amount measured by the light-amount measurement device 25 and the light-amount measurement device 26, and reports the information to the light-source control unit 23.

As described above, angle changes of a galvanometer mirror caused by the aged deterioration etc. may change the amount itself of the light entering the subsequent optical system. In other words, the illumination light emitted from the respective illumination optical systems sometimes vary in intensity.

In the present embodiment by contrast, the light-amount measurement device 25 and the light-amount measurement device 26 measure the light amounts in the respective illumination optical systems, and the intensity of the excitation light output from the light source 1 is adjusted so that the difference between the measured light amounts becomes zero. This configuration enables the adjustment of the emission light amount even when different illumination optical systems have different emission light amounts because of the angle change in the galvanometer mirror. This can prevent variations in light amount between the illumination directions when illuminating sample S in a plurality of directions.

The above light sheet microscope 100 can prevent variations in the illumination direction (i.e., shift of the irradiated plane on sample S) and variations in the emission light amount among a plurality of illumination optical systems even when the angle change occurred in the galvanometer mirror 2.

Also, the present configuration, which uses a plurality of illumination optical systems including similar constituents, facilitates the production etc. Also, the emission of excitation light (sheet light) in opposed directions on the same axis by a plurality of illumination optical systems can greatly reduce cases where an area occurs that is prevented by a scattering medium etc. from being irradiated with the excitation light on the sample (i.e., a shadow occurs).

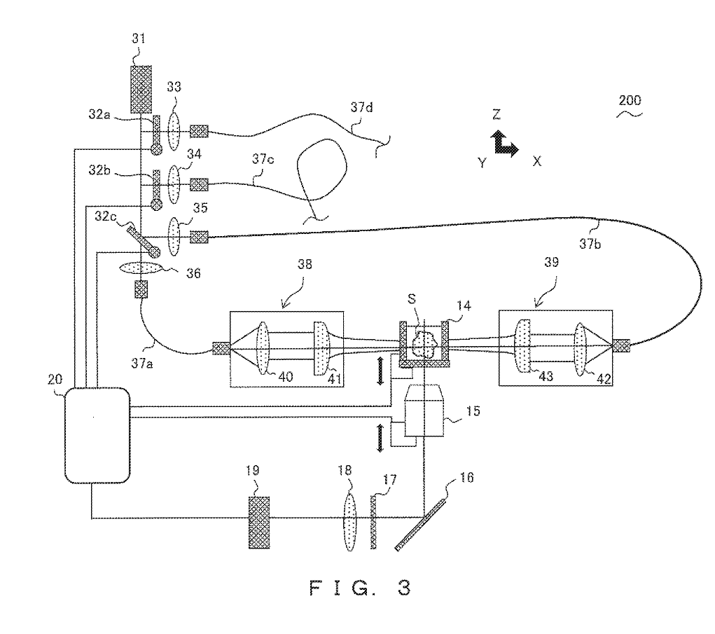

Explanations will hereinafter be given for a light sheet microscope 200 according to the second embodiment. FIG. 3 illustrates a configuration of the light sheet microscope 200.

The light sheet microscope 200 includes a light source 31, flip mirrors 32a, 32b, and 32c, lenses 33, 34, 35, and 36, and optical fibers 37a, 37b, 37c, and 37d. The light sheet microscope 200 further includes an illumination optical system 38 that is arranged subsequently to the optical fiber 37a, and an illumination optical system 39 that is arranged subsequently to the optical fiber 37b. The light sheet microscope 200 further includes an illumination optical system (not illustrated) that is arranged subsequently to the optical fiber 37c, and an illumination optical system (not illustrated) that is arranged subsequently to the optical fiber 37d. The light sheet microscope 200 further includes the objective 15, the mirror 16, the fluorescence filter 17, the lens 18, the light detector 19, and the control device 20. The illumination optical system 38 includes a lens 40 and a cylindrical lens 41, and other illumination optical systems have a similar configuration. Also, the illumination optical systems 38 and 39 irradiate sample S with the excitation light in different directions on the X axis. The illumination optical system (not illustrated) arranged subsequently to the optical fiber 37c and the illumination optical system (not illustrated) arranged subsequently to the optical fiber 37d irradiate sample S with the excitation light respectively in different directions on the Y axis.

The light sheet microscope 200 is different from the light sheet microscope 100 in that the operation of the flip mirror instead of a galvanometer mirror switches the illumination optical system that the excitation light enters and also that four illumination optical systems to illuminate sample S in different directions on the same plane (X-Y plane) are provided.

Even when using a flip mirror as a light switching device, a situation similar to the case of a galvanometer mirror may occur, in which aged deterioration, temperature changes, etc. change the angle is changed by the operation, thereby causing a shift in the traveling direction of the excitation light in the subsequent optical path and thus causing a shift in the illumination direction to sample S. Meanwhile, providing an optical fiber subsequent to the point at which the flip mirror switches the optical path so as to guide the light to the subsequent illumination optical system can prevent the shift in the emission direction. Also, while the light sheet microscope 100 has two illumination optical systems, the number of the illumination optical systems is not limited particularly. Accordingly, two or more illumination optical systems may be included as in the present configuration.

Also, the present configuration may include a beam splitter provided between a lens and the cylindrical lens, and include a light-amount measurement device provided in the direction in which the light is reflected at the beam splitter as in the first embodiment, although FIG. 3 does not illustrate a light-amount measurement device. The provision of a light-amount measurement device enables the light-amount measurement device to measure the amount of the light passing through each illumination optical system even when a variation in the amount of a change in the angle occurs in the flip mirror serving as a light switching device and such a variation changes the amount itself of the light entering the subsequent optical system. This enables the adjustment of the output from the light source so that there is no difference in light amount of emitted excitation light between illumination optical systems.

Also, not only a galvanometer mirror or a flip mirror, but also a mirror that is controlled so that it is inserted and removed with respect to the optical path can serve as the light switching device, and a polarization beam splitter and a wave plate may be inserted and removed with respect to the optical path.

While the first and second embodiments use a galvanometer mirror and a flip mirror as the light switching device, the configuration is not limited to these examples. For example, a phase modulation element (such as LCOS etc.) or an acousto-optical element may instead be used. Phase modulation elements and acousto-optical elements also may have their optical characteristics deteriorated by various factors including water condensation on the light entrance/emission surface caused by temperature changes. However, providing an optical fiber in a subsequent stage so as to guide the light to each illumination optical system that emits the sheet light can prevent a variation in the emission direction and the intensity between the illumination optical systems.

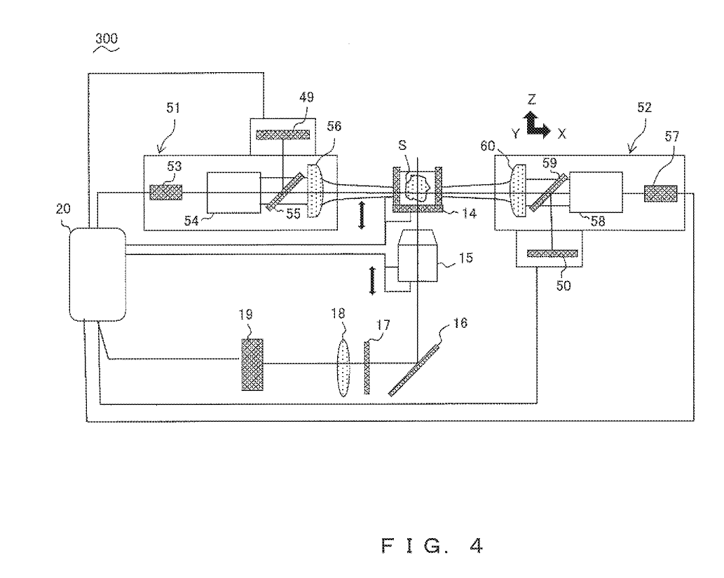

Explanations will hereinafter be given for a light sheet microscope 300 according to the third embodiment. FIG. 4 illustrates a configuration of the light sheet microscope 300.

The light sheet microscope 300 includes illumination optical systems 51 and 52, light-amount measurement devices 49 and 50, the objective 15, the mirror 16, the fluorescence filter 17, the lens 18, the light detector 19, and the control device 20.

The illumination optical system 51 includes a light source 53, a light-flux diameter changing optical system 54, a beam splitter 55, and a cylindrical lens 56. The light-flux diameter of the excitation light output from the light source 53 is changed by the light-flux diameter changing optical system 54, and the excitation light is collimated by the light-flux diameter changing optical system 54, and enters the beam splitter 55. The light transmitted through the beam splitter 55 passes through the cylindrical lens 56, and sample S is irradiated with the light. Also, the excitation light reflected by the beam splitter 55 is guided to the light-amount measurement device 49.

The illumination optical system 52 includes constituents similar to those belonging to the illumination optical system 51, and includes a light source 57, a light-flux diameter changing optical system 58, a beam splitter 59, and a cylindrical lens 60. The light-amount measurement device 50 is provided so that the excitation light reflected by the beam splitter 59 enters the light-amount measurement device 50. In other words, the light sheet microscope 300 includes a plurality of illumination optical systems that respectively emit beams of the excitation light from a plurality of light sources (light sources 53 and 57) to the sample as light sheets in a plurality of directions on the same plane.

In the present configuration, the light-source control unit 23 controls the output and halt of the respective light sources (light sources 53 and 57) belonging to the illumination optical systems. This control changes the illumination optical system to emit the excitation light between the illumination optical systems 51 and 52. In other words, the light-source control unit 23, which is a light source control device, functions as a light switching device that switches the illumination optical system to emit the excitation light from among a plurality of illumination optical systems.

In other words, the configuration of the light sheet microscope 300 can switch the illumination optical system to emit the excitation light by controlling the output of the light source arranged for each of the plurality of illumination optical systems (illumination optical systems 51 and 52), and thus does not include a mechanism to operate a galvanometer mirror etc. Thus, the control device 20 in the present configuration does not have the functional configuration of the deflection-device control unit 21.

The configuration of the light sheet microscope 300 does not include a mechanism that causes a shift in the entering direction of the excitation light, and the excitation light emitted from the light source at a fixed position is guided to pass through the cylindrical lens so that sample S is irradiated with the excitation light. Thus, no shift will occur in the irradiated plane among the plurality of illumination optical systems.

Also, a variation example may employ a configuration in which an acousto-optical modulator (AOM) is provided on each optical path of a stage subsequent to each light source instead of controlling the output and halt of the light sources so as to control the AOM so that the intensity of the excitation light having entered the AOM is switched between modulation state and non-modulation state. In that case, the excitation light traveling toward one of the plurality of illumination optical systems is transmitted without being modulated in order to allow that illumination optical system to emit the excitation light and the excitation light traveling toward other illumination optical systems is modulated by the AOM so that the light is blocked. In other words, the AOM functions as a light blocking mechanism that passes and blocks the excitation light on the respective optical paths subsequent to the plurality of light sources. Also, by controlling the modulation strength of the AOM instead of controlling the output of the light source, it is also possible to perform adjustment so that there will be no difference in light amount of the emitted excitation light between the illumination optical systems.

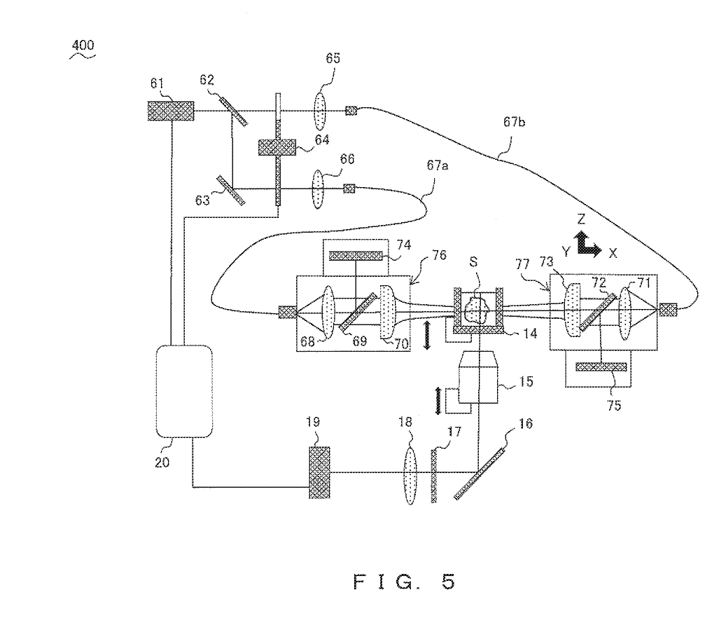

Explanations will hereinafter be given for a light sheet microscope 400 according to the fourth embodiment. FIG. 5 illustrates a configuration of the light sheet microscope 400.

The light sheet microscope 400 includes alight source 61, a beam splitter 62, a mirror 63, a shutter 64, lenses 65 and 66, optical fibers 67a and 67b, and illumination optical systems 76 and 77. The light sheet microscope 400 further includes the objective 15, the mirror 16, the fluorescence filter 17, the lens 18, the light detector 19, and the control device 20.

An example of the beam splitter 62 is a half mirror. The beam splitter 62 is a light splitting device that splits the excitation light so as to make the excitation light output from the light source 51 guide, onto the respective optical paths that are connected to the plurality of subsequent optical fibers (optical fibers 67a and 67b).

The shutter 64 is a light blocking mechanism that passes and blocks the excitation light on each optical path resulting from the splitting by the beam splitter 62.

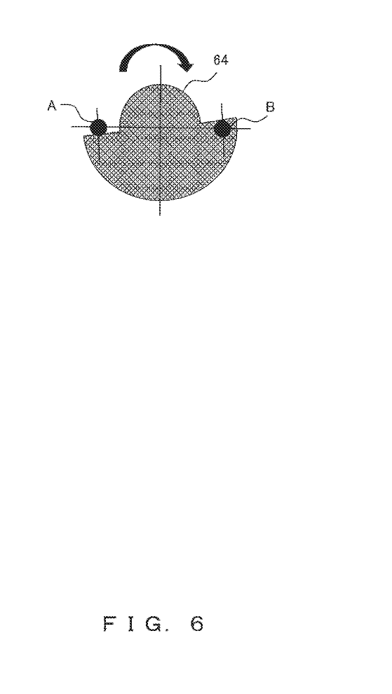

The shutter 64 has for example a shape as illustrated in FIG. 6. FIG. 6 is a sectional view of the shutter 64, in which spots A and B respectively represent the sections of the beams of the excitation light that respectively travel between the beam splitter 62 and the lens 65 and between the beam splitter 62 and the lens 66. The shutter 64 turns in the direction as depicted by the arrow by a driving motor etc. being driven. The shutter 64 changes the position in response to the turning so as to pass or block the excitation light. FIG. 6 illustrates a state in which the shutter 64 makes the excitation light that has been transmitted through the beam splitter 62 pass. Note that the deflection-device control unit 21 of the control device 20 controls the turn of the shutter 64.

The illumination optical system 76 includes a lens 68, a beam splitter 69, and a cylindrical lens 70. In other words, the illumination optical system 76 includes constituents similar to those belonging to the illumination optical system 6 in the light sheet microscope 100. The illumination optical system 77 includes the lens 71, the beam splitter 72, and the cylindrical lens 73, which are similar to those belonging to the illumination optical system 76. In other words, the light sheet microscope 400 includes a plurality of illumination optical systems that respectively emit beams of the excitation light guided from the plurality of optical fibers (optical fibers 67a and 67b) to sample S as light sheets in a plurality of directions on the same plane.

The light detector 19 controls the exposure in synchronization with the turn of the shutter 64 under control of the light-source control unit 23 of the control device 20. Specifically, the light-source control unit 23 starts exposure when the situation becomes one where one of spots A and B of the light in FIG. 6 is passing through the shutter 64 and the other is blocked by the shutter. Also, the light-source control unit 23 halts exposure while the shutter 64 is turning (i.e., when both of spots A and B are passing through the shutter 64). Control such as this can prevent a situation where an image is picked up under a condition that is not suitable for observations with the light amount and the illumination direction varying and the shutter 64 turning.

As described above, a configuration of splitting the excitation light in accordance with the number of the illumination optical systems and a configuration of selectively guiding the excitation light after being split to one of the optical fibers and one of the illumination optical systems may be included. A configuration of turning the shutter such as the present configuration can achieve effects similar to those achieved by the first embodiment while using an inexpensive configuration compared with a configuration that uses a galvanometer mirror etc.

The above embodiments are specific examples provided to facilitate understanding of the invention, and the present invention is not limited to these embodiments. The light sheet microscopes described above allow various modifications and alterations without departing from the inventions described in the claims.

What is claimed is:

1. A light sheet microscope comprising:
a light source configured to output light;
a plurality of optical fibers configured to guide the light that is from the light source;
a plurality of illumination optical systems configured to respectively emit beams of the light guided from the plurality of optical fibers toward a sample as light sheets in a plurality of different directions on a same plane; and
a light switching device that is provided between the light source and the plurality of optical fibers and that is configured to switch an optical fiber that the light output from the light source enters, from among the plurality of optical fibers.

2. The light sheet microscope according to claim 1, wherein
the light switching device is a light deflection device that deflects the light output from the light source so as to switch an optical fiber that the light output from the light source enters, from among the plurality of optical fibers.

3. The light sheet microscope according to claim 2, wherein
the light deflection device is a galvanometer mirror, an acousto-optical element, a phase modulation element, or a flip mirror.

4. The light sheet microscope according to claim 1, further comprising
a plurality of light-amount measurement devices configured to measure a light amount of excitation light passing through each of the plurality of illumination optical systems.

5. The light sheet microscope according to claim 2, further comprising
a plurality of light-amount measurement devices configured to measure a light amount of excitation light passing through each of the plurality of illumination optical systems.

6. The light sheet microscope according to claim 1, wherein
the plurality of illumination optical systems include at least a plurality of illumination optical systems that emit light on a same axis.

7. The light sheet microscope according to claim 1, wherein
the plurality of illumination optical systems are optical systems that respectively include constituents similar to those of others.

8. The light sheet microscope according to claim 4, further comprising
a control device configured to adjust the light amounts of the beams of the light emitted from the plurality of illumination optical systems, on the basis of the light amounts measured by the plurality of light-amount measurement devices.

9. A light sheet microscope comprising:
a light source configured to output light;
a plurality of optical fibers configured to guide the light that is from the light source;
a plurality of illumination optical systems configured to respectively emit beams of the light guided from the plurality of optical fibers toward a sample as light sheets in a plurality of directions on a same plane;
a light splitting device configured to split the light so as to make the light output from the light source guide, to optical paths respectively connected to the plurality of optical fibers; and
a light blocking mechanism that passes or blocks light on each optical path resulting from the splitting by the light splitting device.

10. The light sheet microscope according to claim 9, wherein
the plurality of illumination optical systems include at least a plurality of illumination optical systems that emit light on a same axis.

11. The light sheet microscope according to claim 9, further comprising
a plurality of light-amount measurement devices configured to measure a light amount of excitation light passing through each of the plurality of illumination optical systems.

12. The light sheet microscope according to claim 9, wherein
the plurality of illumination optical systems are optical systems that respectively include constituents similar to those of others.

13. The light sheet microscope according to claim 11, further comprising
a control device configured to adjust the light amounts of the beams of the light emitted from the plurality of illumination optical systems, on the basis of the light amounts measured by the plurality of light-amount measurement devices.

14. A light sheet microscope comprising:
a plurality of light sources configured to output light;
a plurality of illumination optical systems configured to respectively emit beams of light that are from the plurality light sources toward a sample as light sheets in a plurality of directions on a same plane; and
a light switching device configured to switch an illumination optical system to emit light, from among the plurality of illumination optical systems.

15. The light sheet microscope according to claim 14, wherein
the light switching device is a light blocking mechanism that passes or blocks light on each optical path subsequent to the plurality of light sources.

16. The light sheet microscope according to claim 14, wherein
the light switching device is a light source control device that controls output and halt of the plurality of light sources.

17. The light sheet microscope according to claim 14, further comprising
a plurality of light-amount measurement devices configured to measure a light amount of excitation light passing through each of the plurality of illumination optical systems.

18. The light sheet microscope according to claim 14, wherein
the plurality of illumination optical systems include at least a plurality of illumination optical systems that emit light on a same axis.

19. The light sheet microscope according to claim 14, wherein
the plurality of illumination optical systems are optical systems that respectively include constituents similar to those of others.

20. The light sheet microscope according to claim 17, further comprising
a control device configured to adjust the light amounts of the beams of the light emitted from the plurality of illumination optical systems, on the basis of the light amounts measured by the plurality of light-amount measurement devices.
